(19) United States
(12) Patent Application Publication
(10) Pub. No.: US 2016/0102479 A1
(43) Pub. Date: Apr. 14, 2016

(54) CABLE GUARDRAIL SECURITY DEVICE

(71) Applicant: Thomas Scannell, Philadelphia, PA (US)

(72) Inventor: Thomas Scannell, Philadelphia, PA (US)

(21) Appl. No.: 14/689,744

(22) Filed: Apr. 17, 2015

Related U.S. Application Data
(63) Continuation-in-part of application No. 14/511,764, filed on Oct. 10, 2014.

(51) Int. Cl. E05B 65/00; E04H 17/10; E05B 67/00; E04H 17/04

(52) U.S. Cl. CPC E05B 65/00; E04H 17/04; E04H 17/10; E05B 67/00

(57) ABSTRACT

A cable guardrail security device that includes an enclosure having a body with a passageway extending through the body and a locking mechanism to releasably lock the enclosure onto a cable of a cable guardrail over the location of the cable clamps that secure the cable so that the enclosure blocks access to the cable clamps. The security device includes opposing apertures in the enclosure that are designed to receive a shackle of a lock therethrough.

### BACKGROUND OF THE INVENTION

1. Field of the Invention

The present invention relates to the field of cable guardrails, and more particularly to a security device for a cable guardrail.

2. Brief Description of the Related Art

Construction work done to erect buildings is often performed at heights of six feet or higher. When a building site requires work to be done at heights of six feet or greater, fall protection is required. Some types of fall protection that are used include guardrails, warning lights, fall arrest systems and floor covers. According to safety standards, guardrails are to be provided having a top rail, a mid rail and a toe board. OSHA has issued regulations that construction entities and workers are to follow. The top rail of the guardrail must be at least 42 inches from the working surface. Another requirement is that the mid rail be 21 inches from the working surface. The guardrail and the rail components are designed to provide support for workers, such as, for example, where a worker loses balance and grasps onto the rail or is forced against the rail. The top rail is required to support 200 lbs. of force downward and outward. Another requirement is that the cable guardrail top rail must have the top rail flagged very six feet.

There are generally two types of guardrail systems used. One is wood rails, where the rails are constructed from wood beams that are secured together, and another is constructed using steel cable. The steel cable rail systems generally are secured to a structure, such as a beam of the building. The steel cable is generally looped around the structure or through the structure by stranding the cable end, the dead end as it is often known, through or around the structure and securing the end to the cable to form a loop. It is common to use clamps to secure the cable dead end to the cable. A type of clamp used has a saddle and a u-bolt. The clamps are generally used in threes, at the end of the cable, and the clamps are to receive the dead end on the cable, with the u-bolt engaging the dead end cable portion and the saddle being positioned underneath the cable. In the common arrangement, there are three clamps which are spaced apart along the location where the cable dead end overlaps the cable. The clamping arrangement involves the u bolt, the cable dead end on top of the cable and the saddle.

Although guardrails are often installed as a safety precaution, there are instances of injury and even death occurring due to workers falling from a building. The cable guardrails typically are installed in place at the locations and heights of an under construction building and are present to provide safety for workers that are carrying out tasks at heights greater than six feet. The construction of multi-story buildings typically involve the use of steel cable systems, where two steel rails are provided and secured to the building structure, such as, for example, to a beam. Despite the cable safety guardrails having been properly installed, there are still reported accidents suffered by workers due to falls. In many instances, supplies must be lifted to a higher floor for the workers to use. Often, a crane lifts a palette on which the supplies are carried. The safety guardrails in many cases block access for the supplies, or are present at a level that makes it difficult to maneuver the palette of supplies onto the floor. What typically happens is that the cable guardrail or guardrails are released or lowered in order to allow more space for access to the floor to supply materials or building components. Though the lowering of the cables is supposed to be temporary, in some cases, the steel cables forming the cable guardrail are not replaced back to their original position where they previously provided protection. In other cases, the cables are replaced, but they are installed improperly, and therefore, though seemingly appearing in place and looking as if the cable rail will offer protection, it does not. For example, although the OSHA regulation requires the claps to be installed with the u-bolt on the dead end of the cable, and the saddle beneath the cable, in some instances, the clamp is reversed. In other instances an improperly sized clamp may be used, leading to slippage of the cable when a load is applied. At other times, the clamps may be removed to lower the guardrails, and for whatever reason (e.g., the clamp falls, is misplaced or lost) the clamps are not put back, so there may be a cable secured with less than the required number of clamps. An arrangement where originally three clamps secured the cable end may now be done using two clamps, or even a single clamp. In other instances, although well-meaning, individuals removing and replacing the cable clamps my not properly reinstall them (e.g., orienting the clamp incorrectly, or failing to tighten the clamp). When any of these events occur, an unsafe or hazardous condition may be present, as the cable guardrail may not be able to support the load weight that it is designed and required to handle. Although the cable guardrail systems are installed and designed to provide safety for workers working at elevated heights, and these systems often do accomplish that, when the cable guardrail is compromised, dangers, including fatalities, may occur.

### SUMMARY OF THE INVENTION

A cable guardrail security device is provided. According to a preferred embodiment, the cable guardrail security device includes a structure that surrounds the cable dead end and clamps and restricts and regulates access to the clamps in order to prevent unauthorized removal or release of the cable guardrail. A lock also is used to regulate access to the clamps for their removal and replacement. The structure provides a barrier to accessing the clamps and may be referred to as an enclosure, casing or housing.

According to another aspect of the invention, a securing system is provided, where one or more cables are secured to a structure to form a cable guardrail. The cables preferably are installed and secured for disposition at preferred heights, which may be an arrangement of specific heights relative to the working surface per the OSHA requirements, such as, for example, where one cable is at least 42 inches from the working surface, and a second cable forming a mid rail is 21 inches from the working surface. The cable is generally secured to a structure, which may be part of the building being erected, such as, for example, a post or beam. Often, the beams or posts include an aperture or pass through for the cable. A cable may be passed through the opening in the structure (e.g., such as an aperture in a beam structure of a building being erected), and the dead end cable portion being secured to the cable to form a loop around the structure, thereby anchoring the cable end. The cable dead end is secured with clamps, and preferably, with three clamps. The clamps that secure the cable dead end to form the cable loop, preferably may be a u-bolt clamp, with a u-bolt on the top (over the dead end) and a saddle on the bottom. The u-bolts include nuts which are tightened to clamp the cable in a configuration where the loop formed secures the cable end to a structure. The cable opposite end is secured to a structure using any suitable components or methods, which may be similar to the cable end discussed for the first end, or may be done using other suitable means, and preferably, within the building or safety codes. The securing system includes an enclosure which is releasably locked in place at the cable end to minimize and more preferably to restrict access to the clamps used to secure the sable end.

According to a preferred embodiment, the cable security device includes an enclosure that has a passageway for the cable to pass through. The cable may be passed through the passageway of the enclosure, passed through the structure, and then the cable dead end is secured to the cable, preferably with clamps. The cable having passed through the security device allows the security device to be moved along the cable. The security device is moved along the cable so that an end of the security device is beyond the location of the cable clamp connections. A lock is installed to maintain the security device in a blocking position to block or interfere with access to the clamps.

According to some preferred embodiments, the cable securing device may be configured with apertures to receive the shackle of a lock, such as, for example, a padlock. Access to the cable clamps that secure the cable to a structure may be regulated by limiting access to the lock only to those authorized personnel.

According to some embodiments, the enclosure includes openings or windows, or is comprised of an open structure, such as, for example, a lattice, that allows for inspection of the interior of the enclosure so that the cable condition as well as the clamps that secure the cable may be inspected. Openings also provide an exit for water that may have entered the enclosure through rain or snow, washing or the like. According to preferred embodiments, the openings in the barrier structure, such as, the enclosure, are configured to block access to the clamps in the passageway of the enclosure that secure the cable, or at least make access impeded so as to render it too time consuming to attempt to maneuver the clamps.

According to some preferred embodiments, the cable used for the cable guardrail is the suitable cable size that provides safety, and clamps, such as, for example, u-bolts, are sized to correspond with the cable size. For example, according to a preferred embodiment, the cable diameter is ⅜″, and the cable end is secured using u-bolts for handling two ⅜″ inch cable strands.

It is another object to accomplish any one or more of the above objects by providing a cable guardrail security device that has one or more of the above features.

### BRIEF DESCRIPTION OF THE DRAWING FIGURES

FIG. 1 is a perspective view of a cable guardrail security device.

FIG. 2 is a right side elevation view of the cable guardrail security device of FIG. 1.

FIG. 3 is a top plan view of the cable guardrail security device of FIG. 1

FIG. 4 is a front elevation view of the cable guardrail security device of FIG. 1.

FIG. 5 is a perspective view showing a portion of a cable guardrail system with the security device of FIG. 1 installed thereon in a locked condition.

FIG. 6 is a sectional view of the system of FIG. 5, showing the security device and a clamp with a cable secured by the clamp.

FIG. 7 is a perspective view of an alternate embodiment of a cable guardrail security device as viewed from the rear of the right side of the device looking forward, the security device being shown with a cable looped and secured therein.

FIG. 8 is a perspective view of the cable guardrail security device of FIG. 7, shown with the device in phantom lines to illustrate a preferred connecting arrangement for connecting a cable end with clamps.

FIG. 9 is a perspective view of the cable guardrail security device of FIG. 7, as viewed from the front right side of the device looking rearward.

FIG. 10 is a front elevation view of the cable guardrail security device of FIG. 7.

FIG. 11 is a top plan view of the device of FIG. 7.

FIG. 12 is a right side elevation view of the device of FIG. 7.

### DETAILED DESCRIPTION OF THE INVENTION

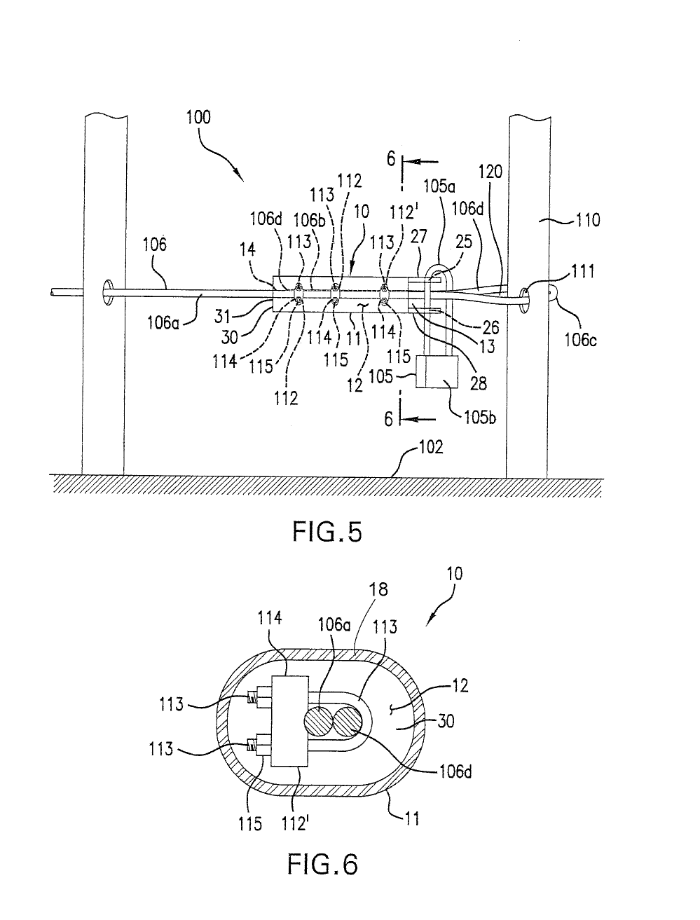

Referring to the drawing figures, there is illustrated a cable guardrail security device 10. The security device 10 is shown including an enclosure 11 that has a passageway 12 therethrough. The enclosure 11 has a first opening 13 and a second opening 14, and is illustrated as a tubular structure. The first opening 13 and second opening 14 communicate with the passageway 12 of the enclosure 11. According to a preferred embodiment, the first opening 13 is provided at one end of the enclosure and the second opening 14 is provided at the other end thereof The enclosure passageway 12 as well as the openings 13 and 14 are designed to be large enough so that the cable of a guardrail cable may pass through. Preferably, at least one of the first opening 13 and second opening 14 is suitable so that two diameters of cable may pass therethrough, such as the cable as well as a cable dead end (see FIG. 5). According to a preferred embodiment, the passageway 12 has a length and a width, and the cable may pass through the length of the passageway 12.

A locking means for locking the enclosure 11 so that the enclosure 11 will remain in a position that blocks access to a cable securing component, such as the clamps that secure a cable dead end onto the cable. The locking means, according to a preferred embodiment of the device 10, includes apertures 25,26 disposed in the enclosure 11, and preferably provided at one end thereof. The device 10 is shown according to a preferred embodiment, with a pair of arms 27,28 disposed on the enclosure 11 and provided in opposing relation. The apertures 25,26 preferably are disposed in the respective aims 27,28. The apertures 25,26 are sized to permit passage of a lock shackle, such as, for example, the lock shackle of a padlock. Alternatively, the apertures 25,26 may be suitably sized to receive another type of locking component, such as, for example, a cable whose ends are secured with a lock (e.g., a padlock).

According to a preferred embodiment, the enclosure 11 may include a cap 30. The cap 30 is shown provided at the enclosure end opposite the end where the arms 27,28 are located. The cap 30 preferably is secured to the enclosure body 18 by any suitable means, including welding or forming of the cap with the enclosure and bending, or combinations of these methods, as well as other methods. The cap 30 has an aperture 31 therein, which preferably is centrally located therein. The aperture 31 is sized to permit the passage of a cable of the guardrail cable rail on which the security device 10 is to be installed. The aperture 31 also may facilitate guiding the device 10 along the cable during installation, and may facilitate stabilizing the device 10 when installed on the cable. The end cap 30 may be provided having the same thickness as the wall 19 forming the enclosure body 18, or alternatively, the end cap 30 may be provided having a different thickness.

The enclosure 11 preferably is elongated and, according to preferred embodiments, may be elliptically shaped. According to a preferred embodiment, where the enclosure is elliptically shaped, the arms 27,28 preferably are disposed on the longer, opposite sides of the enclosure 11. According to some embodiments, the longer opposite sides of the enclosure 11 may include a flat or substantially flat portion.

The arms 27,28 preferably extend beyond the enclosure body 18, and, according to a preferred embodiment, the arms 27,28 are tapered, with a wider portion attaching to the enclosure body 18 and a narrower portion at the termination of each respective arm 27,28. The enclosure 11 as well as the aims 27,28 preferably are constructed from a suitable material that is suitably strong and resistant to or not easy to cut through. One suitable material from which the device 10 may be constructed is steel. The steel may have a suitable thickness to withstand bending and so that cutting the steel, particularly, the portion where the apertures 25,26 are located, such as, the arms 27,28, is not readily done. One suitable thickness for steel may be ⅛ of an inch, although the structure or enclosure may be constructed having other thickness dimensions, including varied thicknesses for the wall. According to one embodiment, the device 10 may be formed by creating an enclosure from a sheet of steel, and may involve laser cutting of the steel from a sheet, and bending the sheet to form the device configuration, and finally, welding the enclosure 11 along its length and welding the end cap 30 to the end of the enclosure body 18. The enclosure end cap 30 may be fowled as part of the sheet from which the enclosure body 18 and an us 27,28 are cut. The apertures 25,26 preferably may be formed in the workpiece sheet before the enclosure 11 is bent and welded. Alternatively, the components of the device 10, such as, for example, the enclosure 11, arms 27,28 and end cap 30, may be separately formed or provided, and may be connected together, such as by welding the components together to form the device.

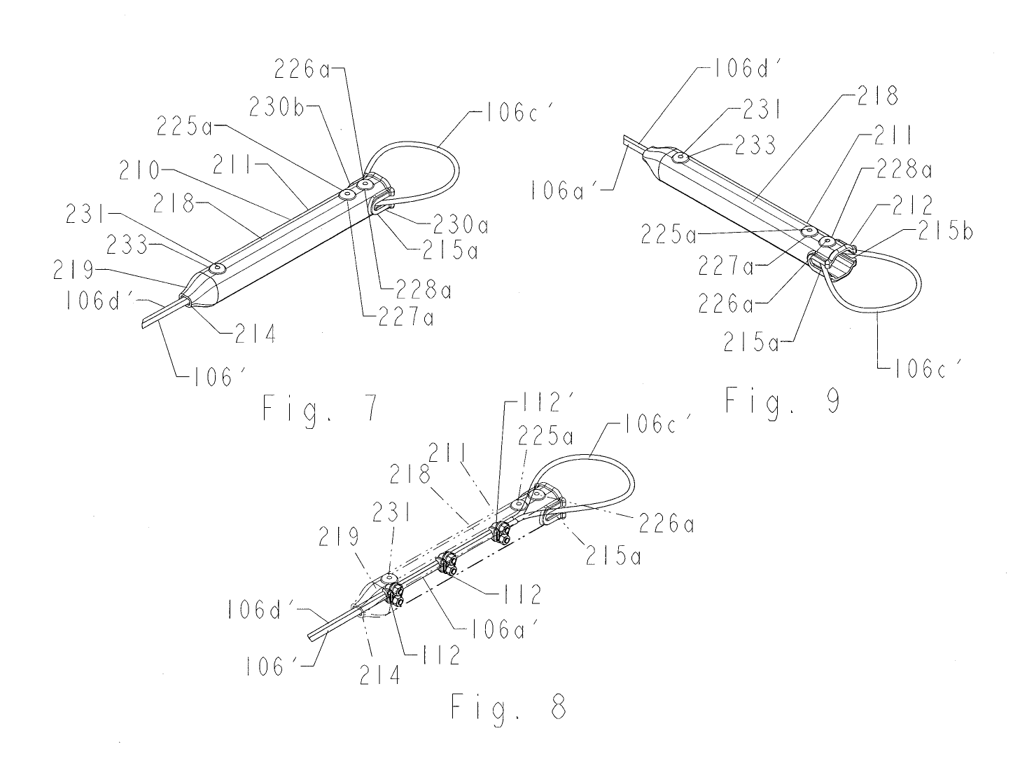

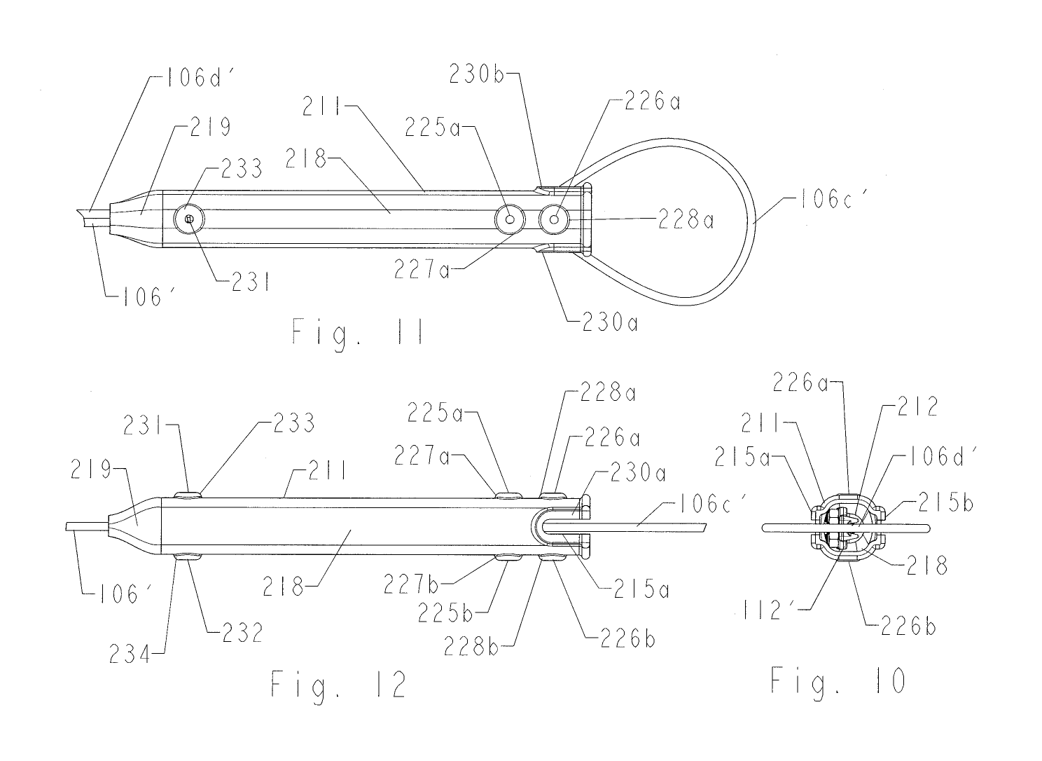

Referring to FIGS. 7-12, an alternate embodiment of a cable guardrail security device 210 is shown. The device 210 is configured as an enclosure 211 having a passageway 212 therethrough. The enclosure 211 has a body 218 with a first opening 213 and a second opening 214, and, like the device 10, is shown as a tubular structure. The first opening 213 is provided at one end of the enclosure 211 and the second opening 214 is provided at the other end thereof. In the embodiment illustrated, there are slots or recesses 215a,215b provided at the front end of the enclosure 211. According to a preferred embodiment, the recesses 215a,215b are formed in the enclosure body 218 and open into the front or first opening 213. The recesses 215a,215b preferably are oppositely disposed and located on opposite sides of the enclosure 211. The recesses 215a,215b, preferably are disposed to provide a range of width for a cable end passing through and forming a loop at the end of the enclosure 211. As illustrated, the cable 106′ shown in FIGS. 7-12 is formed into an end loop 106c′ which passes through the recesses 215a,215b. The recesses 215a,215b provide a larger radial expanse for the cable loop 106c′. The recesses 215a,215b allow for the locking apertures 225a,225b (or 226a,226b) to be positioned forward of the location where the clamped parallel cable strands (106a′,106d′, see FIG. 8) begin to diverge to form the loop 106c′.

The device 210 is shown having locking means, which according to a preferred embodiment, includes a series of apertures 225a,225b and 226a,226b provided on the enclosure 211. The apertures 225a,225b and 226a,226b are provided in opposingly situated pairs and are located near the front of the device 210, with a row of apertures 225a,226a on the top of the enclosure 211 and a row of apertures 225b,226b on the bottom of the enclosure 211. The apertures 225a,225b,226a,226b are sized to permit passage of a lock shackle (e.g., of a padlock) or other type of locking component, such as, for example, a cable whose ends are secured with a lock (e.g., a cable lock).

Each opposing aperture pair 225a,225b and 226a,226b is provided at a different location along the length of the enclosure 211 and set back from the front opening 213 of the enclosure 211. As illustrated, the aperture pairs 225a,225b and 226a,226b provide at least two different locking locations at which to secure the device 210 to a cable end. The device 210 is releasably secured on a cable with a lock, such as, for example, a lock shackle or cable lock. A strong flexible strand lock may be used to secure the cable guardrail security device 210 on a cable, such as a wire or cable lock, such as, for example a lock that has a strand secured to a lock pad at one end and has a head at the other end of the strand that may be releasably secured to and removed from the lock pad. The lock shackle or strand may be used to secure the cable guardrail security device 210 on the cable 106′ of a cable guardrail system (such as the system shown in FIGS. 5 and 6) by passing the lock strand or shackle through a top and bottom aperture (e.g., 225a,225b or 226a,226b), and preferably through two opposing apertures (225a,225b or 226a,226b). The apertures 225a,225b,226a,226b also serve to allow exit of water, dirt and other debris from the enclosure space 212. According to a preferred embodiment, one of the front set of apertures may serve as locking apertures to receive a lock while the other set of apertures provides relief from water and debris (and essentially function as weep holes).

According to a preferred embodiment, depending bosses 227a,227b and 228a,228b may be provided at the respective apertures 225a,225b and 226a,226b. According to a preferred embodiment, flanges 230a,230b may be provided at the perimeter of each recess 215a,215b. The weep apertures 231,232 also may have respective depending bosses 233,234.

The security device 210 is constructed similar to the device 10 shown and described herein, with the enclosure passageway 212 as well as the first or front opening 213 and second or rear opening 214 being large enough so that the cable of a guardrail cable may pass through, and, according to some preferred embodiments, may be sized to accommodate two diameters of cable therethrough (see, e.g., FIGS. 7-12). The security device 210 may be made from the same material or materials as the device 10.

As shown in the embodiment of FIGS. 7-12, the elongated enclosure body 218 has a tapered end portion 219. The second or rear opening 214 is provided at the tapered end portion 219. In some preferred embodiments, the tapered end portion 219 may be conical in configuration. According to preferred embodiments, drainage means for draining water, dust and other debris that may collect within the enclosure 211 may be provided. Apertures 231,232 are provided at the rear end of the enclosure 211. According to alternate embodiments, apertures serving as weep holes may be provided at different or additional locations along the body 218.

Each security device 10, 210 may be provided separately from the other components used for constructing a cable guardrail system (e.g., cable, locks, clamps, tools) or alternatively, according to some embodiments, may be provided in a kit form that includes one or more cable guardrail security devices 10,210, and one or more other components, such as, locks, cables, clamps, and/or tools.

The security device 10 may be used in accordance with the following example, where the security device 10 is installed in a cable guardrail system 100, used above an elevated work surface, such as, for example, a floor 102 of a building being erected. Similarly, the cable guardrail security device 210 may be used in the manner shown and described in connection with the device 10, and the example would apply to the device 210, as well.

A lock 105 preferably secures the device 10 on the cable guardrail, and is shown secured to the upper cable 106 of the guardrail system 100. The cable preferably is a steel cable, suitable is strength and/or dimension to meet the safety requirements. A preferred cable is ⅜ inch cable. The cable is shown having a main cable portion 106a, and a dead end portion 106b. The cable 106 also forms a loop 106c and is shown secured to a structure, such as, for example, the beam 110. The cable 106 is shown passing through an aperture 111 in the beam 110. The dead end portion 106b of the cable 106 is secured to the main cable portion 106a. A preferred component used to secure the cable dead end 106b is a u-bolt clamp 112, shown having a shackle 113, a saddle 114, and nuts 115 at each threaded shackle end of the u-bolt to tighten the u-bolt onto the cable 106, in particular the cable main portion 106a and dead end 106b. Preferably, and in accordance with the recommended practice for securing the cable 106, the dead end 106b cable portion is provided so the shackle 113 will engage it, and the main cable portion 106a is provided to engage the saddle 114. In the arrangement illustrated, the cable dead end portion 106b is on the top and the cable main portion 106a is below it. In the preferred arrangement shown, the cable is secured using three u-bolt clamps 112. The security device 10 preferably is installed on the cable 106 prior to securing the cable 106 to a structure. In the arrangement illustrated, the security device 10 is installed on the cable 106 before the cable 106 is passed through the structure opening 111. The cable end, such as the leading end 106d, is passed through the passageway 12 of the device 10. This is done preferably by passing the cable end 106d through the end cap aperture 31 and then through the body 18 of the enclosure 11. The cable end 106d is then secured to the structure 110. In the example illustrated, the cable end 106d is passed through the opening 111 of the beam 110. The security device 10, still on the cable main portion 106a, is moved out of the way of the connection area by sliding it along the cable 106 (away from the location on the cable where the clamp connections are to be made), and the cable dead end 106b is secured to the cable main portion 106a with clamps 112. Once the cable dead end 106b is secured to the cable main portion 106a, the security device 10 is then installed in position. Referring to FIGS. 5 and 6, according to a preferred arrangement and installation, the u-bolt clamps 112,112′ are installed in an orientation where the cable dead end 106d is at the upper portion of the u-bolt shackle 113 and where the main cable portion 106a is on the saddle 114 (the u-bolt clamp 112′ being shown in FIG. 6). The length of the enclosure 11 is suitable to prevent or make it difficult to access the clamps 112,112′ therein. Although the installation in FIG. 6 is shown with a single cable 106 installed to form a cable guardrail, according to preferred embodiments, there may be another cable barrier that is provided parallel to the cable 106, and which may be secured in the same manner, also with a cable guardrail security device 10, where the enclosure 11 covers clamps 112 used to secure the cable end. According to some preferred embodiments, a first cable is provided about 42 inches (or more) above the floor or surface, and a second cable is provided at about 21 inches above the floor or surface to form a mid rail of the cable guardrail.

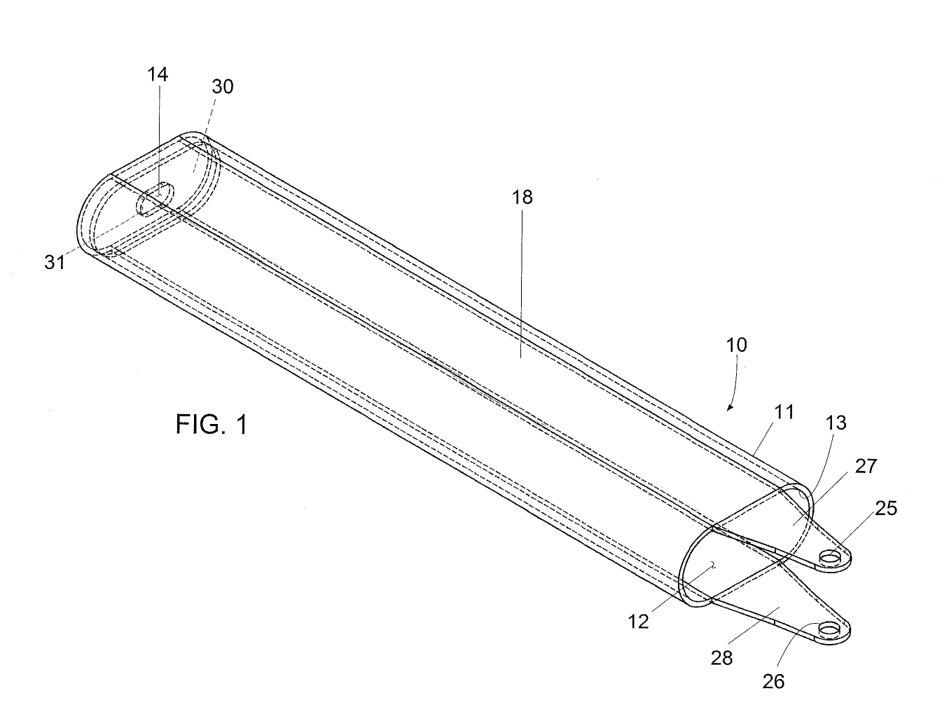

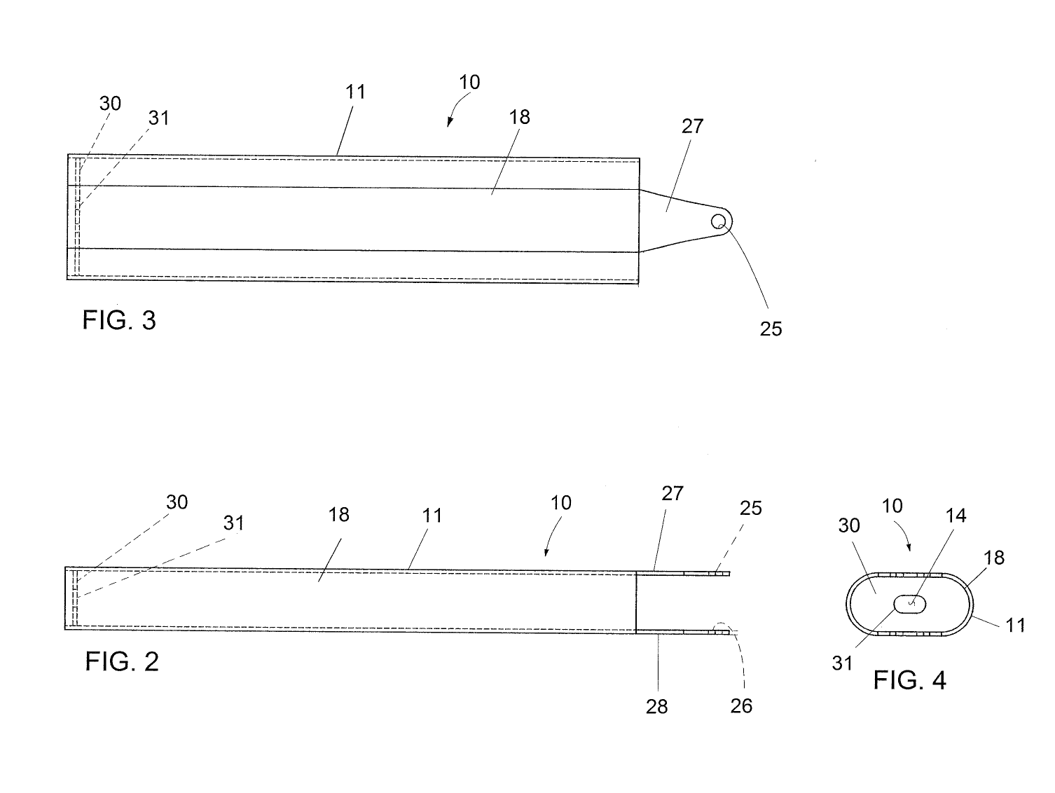

The security device 10 is moved along the cable 106 to cover the clamps 112. As best shown in FIGS. 1, 2 and 5, the apertures 25,26 are aligned to receive a locking component. In the example illustrated, a locking component is a padlock 105 having a lock shackle 105a. The apertures 25,26 are aligned with the loop, and an end of the lock shackle 105a is released from the lock pad or keeper 105b and installed in the apertures 25,26 by passing the shackle 105a through the apertures 25,26. The lock shackle 105a also passes through the inner space 120 of the cable loop 106c. The lock shackle 105a is then clamped back to its locked position in the pad or keeper 105b. With the lock 105 in place, the security device 10 remains limited in its range of movement, and blocks access to the clamps 112. The enclosure 11 is secured on the cable 106 in an interfering position that interferes with access to the clamps 112.

Access to the clamps 112 therefore may be accomplished by reversing the procedure used to secure the device 10 on the cable, namely, unlocking the lock 105 to release the lock shackle 105a from the pad 105b and removing the lock shackle 105a from the apertures 25,26. With the lock shackle 105a removed, the security device 10 may be moved along the cable 106 (rearward or way from the cable loop 106c) to provide access to the clamps 112. The clamps 112 may be disengaged to loosen or lower the guardrail cable 106. Once the guardrail cable 106 is no longer required to be lowered, the cable 106 may be re-secured to the structure 110, and the security device 10 reinstalled, in accordance with the procedures discussed. The lock 105 is shown installed with the lock shackle 105a dividing the passageway opening into a first opening 12a and a second opening 12b, which are disposed on opposite lateral sides of the installed lock shackle 105a. In this arrangement, the cable loop 106c formed of the incoming and outgoing cable portions, has one cable portion on one lateral side of the lock shackle 105a, and another cable portion on the other lateral side of the lock shackle 105a. If the security device 10, while locked, is attempted to be removed (or slid along the cable 106) to provide access to the clamps 112, the lock shackle 105a will engage the intersection of the cable portions 106a, 106b, near the first or leading clamp 112′ (the prime symbol being used to designate the leading clamp 112′ of the clamps 112, through the clamps 112 and 112′ may be the same), and prevent further movement of the device enclosure 10. The clamps 112 will remain blocked by the enclosure 11 until the lock 105 is actuated to release the lock shackle 105a from the pad or keeper 105b.

The security device 10 is shown having structure referred to as an enclosure 11. The enclosure 11 may have weep holes provided therein to allow for drainage, such as, where exposed to elements (e.g., snow and rain), or to allow water from the building process 6, such as washing and the like, to drain in the event water should enter the enclosure 11. The enclosure 11 is shown having a solid wall configuration, but, according to alternate embodiments, may include other forms, such as, for example, a lattice, fence, fenestration or the like. For example, the enclosure 11 may be constructed having openings to permit visibility for inspection of the cable and securing components, such as, for example, the clamps used to secure the cable. The structure or enclosure is configured to be locked into position to block access to the clamps 112 in order to prevent unauthorized removal of the cable 106 or clamps 112 used to secure the cable 106. According to preferred embodiments, any openings in the barrier structure or enclosure are suitably small so as to prevent the usage of a tool to release the clamps from engagement with the cable while the structure, such as the enclosure, is in place. Although the apertures 25,26 are shown provided in the arms 27,28, the apertures 25,26 may be provided in the enclosure body 18. Preferably, the apertures 25,26 oppose each other so that they are aligned to receive a straight portion of a lock shackle.

Referring to FIGS. 7-12, the cable 106′ may be secured to a structure as shown and described herein in connection with the device 10 and cable 106 (see e.g., FIGS. 5 and 6). The cable 106′ may be the same cable 106 shown and described herein in connection with the security device 10, and preferably is installed and secured to a structure as described herein. As shown in FIG. 8, clamps 112,112′ (which are the same clamps 112,112′ described herein in connection with the device 10 and cable 106 as shown in FIGS. 1-6) secure the cable dead end 106d′ to the cable main portion 106a′.

These and other advantages may be realized with the present invention. While the invention has been described with reference to specific embodiments, the description is illustrative and is not to be construed as limiting the scope of the invention. For example, although the rear opening 31 of the security devices 10 is shown with a single cable passing through it, and the security device 210 is shown with a pair of cables passing through the end 213, the devices 10,210 may be used with either a single cable passing through the device end (e.g., where the cable leading end passes through the end, and then the front of the device, forms a loop, and is then secured within the enclosure 11,211) or two lengths of cable passing through the end (e.g., where the cable leading end forms the loop and is returned through the end of the enclosure 11,211 (see FIGS. 7-9)). The excess cable end passing through the device end may be stranded or cut. Various modifications and changes may occur to those skilled in the art without departing from the spirit and scope of the invention described herein and as defined by the appended claims.

What is claimed is:

1. A cable guardrail security device comprising:
an enclosure having a body;
a passageway extending through said body;
locking means provided at one end of said enclosure body.

2. The device of claim 1, including opposing apertures provided in said enclosure body.

3. The device of claim 2, wherein said opposing apertures are provided at one end of said enclosure body.

4. The device of claim 3, including a pair of alms disposed at one end of said enclosure and in opposing relation; and wherein said apertures are disposed in said arms.

5. The device of claim 2, further including a lock having a shackle, wherein said lock shackle diameter is smaller than the diameter of said apertures.

6. The device of claim 2, including an end cap provided at one end of said enclosure, said end cap having an aperture therein, and wherein said end cap aperture communicates with said passageway.

7. The device of claim 6, including a pair of arms disposed at one end of said enclosure and in opposing relation; wherein said apertures are disposed in said arms, and wherein said end cap is provided at the enclosure end opposite that of the end on which the arms are disposed.

8. The device of claim 7, wherein said passageway extends through said opposing arms.

9. The device of claim 1, wherein said enclosure is tubular.

10. The device of claim 1, wherein said enclosure is elliptical.

11. The device of claim 1, wherein said enclosure comprises a lattice.

12. The device of claim 1, wherein said enclosure includes weep holes.

13. The device of claim 1, wherein said enclosure has fenestrations therein.

14. A cable guardrail system comprising:
at least one cable for forming a cable rail of a cable guardrail;
the cable guardrail security device of claim 1;
means for securing the cable end onto itself to faun a loop at said cable end;
a lock for locking said cable guardrail security device to said loop formed at said cable end.

15. The system of claim 14, wherein said means for securing the cable end onto itself comprises a u-bolt clamp.

16. The system of claim 15, wherein three u-bolt clamps are provided to secure the cable end onto itself; wherein said cable guardrail security device of claim 1 includes opposing apertures provided in said enclosure body and an end cap provided at one end of said enclosure, said end cap having an aperture therein, and wherein said end cap aperture communicates with said passageway, and wherein said end cap aperture is larger in diameter than the diameter of said cable.

17. In a cable guardrail arrangement with a cable guardrail security device, wherein at least one cable is provided and is secured to a structure using at least one clamp, the cable having at least one end that forms a loop that connects to said structure, and wherein said clamp secures the cable end to the cable to forms the loop, the improvement comprising:
a structure placed on the cable at the location where the clamp is located, the structure having a first end and a second end, the clamp being maneuverable to secure and release the clamp from clamping engagement with the cable, said structure being disposed to block maneuverability access to the clamp; and a lock being provided at an end of the structure to lock the structure to the cable.

18. The cable security arrangement of claim 17, wherein said structure is a tubular structure that is locked in position to prevent movement of the structure to a location along the cable that permits access to the cable clamps.

19. A cable security device comprising:
a structure having a body with a passageway therethrough; and
a locking mechanism.

20. The device of claim 19, the locking mechanism including a releasable blocking element that is disposed in transverse relationship to the passageway.

21. The device of claim 19, wherein the releasable blocking element is removably securable to the body.

22. The device of claim 21, the structure including at least one opening therein for viewing into the passageway.

23. The device of claim 22, the locking mechanism having a locking component that is removably positioned and passes through the apertures in each said arm, said locking component traversing the passageway.

24. The device of claim 3, wherein said arms are formed as extensions of said elongate body and are spaced apart from each other.

25. The device of claim 1, wherein said body has a front opening and a rear opening, wherein said passageway spans between said front opening and said rear opening, and wherein a pair of opposing recesses are provided in the enclosure body at said front opening.

26. The device of claim 1, wherein said body has a front opening and a rear opening, wherein said passageway spans between said front opening and said rear opening, and wherein said enclosure body has a tapered portion near said rear opening.
